(19) United States
(12) Patent Application Publication
(10) Pub. No.: US 2002/0098376 A1
(43) Pub. Date: Jul. 25, 2002

(54) Friction guard blade and a method of production thereof

(76) Inventor: Harry C. Morris, Moorestown, NJ (US)

Correspondence Address: LICATLA & TYRRELL P.C., 66 E. MAIN STREET, MARLTON, NJ, 08053, US

(21) Appl. No.: 09/768,710

(22) Filed: Jan. 24, 2001

Related U.S. Application Data
(60) Provisional application No. 60/242,107, filed on Oct. 20, 2000.

(51) Int. Cl. B32B 15/00

(52) U.S. Cl. 428/667; 428/935; 205/283

(57) ABSTRACT

A friction resistant blade having a protective layer is provided. A method for producing the friction resistant blade is also provided.

### INTRODUCTION

This patent application claims the benefit of provisional patent application Serial No. 60/242,107, filed Oct. 20, 2000.

### FIELD OF THE INVENTION

This invention relates to prolonged life coater and doctor blades used in paper and printing applications and to methods of their production. Blades are the dominant means of applying inks and coatings to paper and packagings. The blades and method of the present invention achieve a friction resistant blade edge which allows coating or ink to be evenly applied to paper or board. The wear resistant blade has a longer life than conventional steel blades reducing the loss in production time due to frequent replacement of blades.

### BACKGROUND OF THE INVENTION

The paper or board manufactured for publication or packaging applications is frequently coated prior to printing. Properties such as opacity, gloss, smoothness and “printability” of a coated sheet are far improved over those of an uncoated sheet. Typically the coating is applied as a liquid mixture of clay, pigments, starch and/or other binders.

Coater blades are used for metering coatings and in particular waterborne calcium carbonate or clay based coatings on high grade paper used in the printing and packaging industry. Various types of coaters are used within the papermaking industry, but it is generally accepted that the highest quality coated paper surface is obtained using a blade coater. Printing doctor blades are used for metering ink in engraved cylinder used in printing. The coater blade scrapes or meters the amount of coat weight applied to the sheet, leaving a smooth, glossy surface. Any imperfection in the blade or its working edge will cause scratches and/or a non-uniform application of the coating. Also, because the coating itself contains abrasive particles the coater blade is subject to continuous and adverse wear. Therefore in order to maintain sheet quality, the coater blades on a paper machine must be changed out at regular intervals. Paper machine doctor blades are also used in paper machines in many positions for maintenance and cleaning.

Change out intervals, typically are in the order of 2-6 times per day or more. Production losses are incurred due to the time needed to replace a blade and also because the operation of a new blade usually requires adjustment to ensure uniform coating and acquire distribution across the width of the machine. Some production losses due to coater blade changes are able to be reduced by scheduling the coater blade changes to coincide with other maintenance items that can be carried out while the machine runs. A wear resistant coater blade with a ceramic edge is available for use in coating. Ceramic edge blades can last several times longer than conventional steel blades, but regular replacement is still required. Therefore, lost production time is still substantial and the cost of ceramic blades is significantly more than that of the conventional steel blades.

A continuous crepe system is available for paper finishing. For example, U.S. Pat. No. 5,007,132 (Reid et al.) discloses use of a continuous blade which is tugged along the width by intermittently driven clamps in order to form the crepe in the paper. Such tugging, however adversely effects the smoothness and quality of coating on the coated paper or board resulting in streaks or scratches on the coating.

In the present invention, a friction resistant blade with a protective edge is provided which solves the problems of frequent change out, poor quality products, and uneven application of coatings.

### SUMMARY OF THE INVENTION

An object of the present invention is to provide a friction resistant blade with a protective layer. The protective layer is preferably chromium applied to at least the edge of the blade via electroplating.

Another object of the present invention is to provide a method of producing a friction resistant blade which comprises applying a protective layer, preferably a layer of chromium, to a blade-shaped substrate base, preferably via electroplating.

### BRIEF DESCRIPTION OF DRAWINGS

FIG. 1 shows a friction resistant blade useful in the papermaking and printing industry and commonly referred to as a coater or doctor blade.

FIG. 2 shows a cross-sectional view of a friction resistant blade.

### DETAILED DESCRIPTION OF THE INVENTION

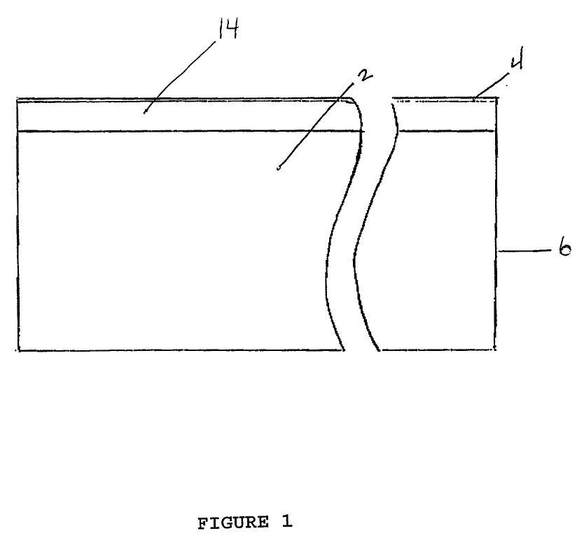

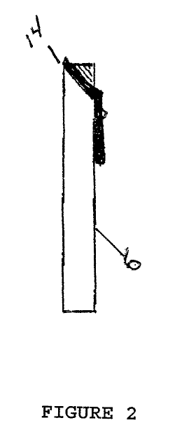

As shown in FIGS. 1 and 2, the present invention is a friction resistant coater or doctor blade. The blade 1 is comprised of a substrate base 2 formed in the shape of a blade with an edge 4. The edge 4 of the blade may be either beveled or square. The substrate base 2 is coated with a protective layer 14. The protective layer 14 is preferably chromium. More preferably, the protective layer 14 comprises electroplated hard chrome. Alternatively, the protective layer 14 may comprise electroless nickel or another suitable protective material as would be known to one of skill in the art upon reading this disclosure. The protective layer may cover all or any portion of the blade. However, in a preferred embodiment, the protective layer 14 is present on at least the blade edge 4 and may extend down the face 6 of the blade 1. The layer thickness may vary from 0.0001 inch to 0.015 inch and extend down the face 6 of the blade 1 from ⅜ inch to ¾ inch depending on the desired application. The length of the blade 1 may vary typically from 6 inches to 600 inches or more depending upon the application. The width of the blade 1 also varies typically from 0.5 inches to 6 inches depending on the desired application. The thickness of the blade may vary from about 0.002 to about 0.125 inches.

The blade 1 is formed of a substrate material, preferably carbon strip steel, stainless steel, stainless alloy, bronze or monel, depending upon desired hardness. The protective layer 14 on the blade 1 increases the wear of the blades and also enhances the performance of the blades and the products of papermaking or printing applications such as metering of coating or ink, maintenance or doctoring applications wherein these blades are used. The blade 1 can be coiled or fashioned in a roll-like manner.

An embodiment wherein the edge 4 of blade 1 is beveled is depicted in FIG. 2. The angle of this bevel may vary from about 1° to about 90°.

Also provided is a method of making a friction resistant blade comprising applying to a blade-shaped substrate base a protective layer preferably to areas of the blade-shaped substrate base which contact various coatings used in paper making and printing applications. In a preferred embodiment, the protective layer is applied at least to the edge of the substrate base and can extend down the face of the substrate base. Preferably the protective layer is chromium and is applied via electroplating to the blade-shaped substrate base. However, other methods known in the art for application of a protective layer can also be used. The protective layer can vary according to application in thickness from 0.0001 inch to 0.015 inch and can extend down the face of the blade from ⅜ inch to ¾ inch depending on the desired application.

If an angled edge is desired, the blade angles are formed and then tested for conformity with an optical comparator. The blades are machine tested for hardness. Blades are examined for potential flatness or surface defects. A surface finish microscope is used to inspect the bevel finish. The blade may be further finished or polished. The blades may be punched to meet application specification. Blades may further be packaged in coiled rolls and with protective taped edges.

The methods and blades of the present invention are particularly useful for doctor blades and coater blades.

As would be understood by one of skill in the art upon reading this disclosure, the dimensions of the blade, protective layer thickness and the extent of blade coverage with the protective layer provided herein are merely exemplary and may be varied routinely by those of skill in the art depending upon the desired application.

What is claimed is:

1. A friction resistant blade comprising a blade-shaped substrate base with an edge and a protective layer applied to said blade-shaped substrate.

2. The friction resistant blade of claim 1 wherein the protective layer is applied to at least the edge of the blade-shaped substrate.

3. The friction resistant blade of claim 1 wherein the protective layer comprises chromium.

4. The friction resistant blade of claim 1 wherein the protective layer is electroplated hard chrome.

5. The friction resistant blade of claim 1 wherein the blade-shaped substrate base comprises carbon strip steel, stainless steel, stainless alloy, bronze or monel.

6. The friction resistant blade of claim 1 wherein the edge is beveled.

7. The friction resistant blade of claim 1 wherein the edge is square.

8. A method of producing a friction resistant blade comprising applying a protective layer to a blade-shaped substrate base, said layer being applied to areas of the blade-shaped substrate which contact coatings used in papermaking, board coating, paper machine maintenance and printing applications.

9. The method of claim 8 wherein the protective layer comprises chromium.

10. The method of claim 9 wherein the chromium is applied via electroplating.
